(19) United States
(12) Patent Application Publication
(10) Pub. No.: US 2002/0005385 A1
(43) Pub. Date: Jan. 17, 2002

(54) Water treatment systems and methods

(76) Inventors: Donald B. Stevens SR., Port Washington, NY (US); Anthony M. Wachinski, Millneck, NY (US); Thomas Wingfield, South Huntington, NY (US)

Correspondence Address: LEYDIG VOIT & MAYER, LTD, 700 THIRTEENTH ST. NW, SUITE 300, WASHINGTON, DC, 20005-3960, US

(21) Appl. No.: 09/847,516

(22) Filed: May 3, 2001

Related U.S. Application Data
(63) Continuation of application No. 09/654,079, filed on Sep. 1, 2000.
(60) Provisional application No. 60/152,127, filed on Sep. 2, 1999.

(51) Int. Cl. C02F 1/30

(52) U.S. Cl. 210/748; 210/652; 210/198.1; 210/203

(57) ABSTRACT

Systems and methods for treating wastewater or source water are disclosed. Water is directed through a filter assembly having a filter medium and is irradiated by a radiation assembly. In preferred embodiments, the filter medium may be microporous or finer; the radiation assembly may be arranged to irradiate water upstream of the filter medium of the filter assembly; and/or the radiation assembly may be arranged to irradiate water upstream of the filter medium of the filter assembly.

This is a continuation of U.S. application Ser. No. 09/654,079, which was filed on Sep. 1, 2000 and is incorporated by reference.

### TECHNICAL FIELD OF THE INVENTION

The invention relates to water purification; in particular, to the use of radiation and filtration in water purification.

### BACKGROUND OF THE INVENTION

Filter media have been used for wastewater treatment, e.g., industrial wastewater treatment or municipal wastewater treatment, and for source water treatment, e.g., industrial source water treatment or municipal drinking water treatment, to remove particulate matter, viruses, microorganisms, dissolved materials and various other contaminants. However, such filters have long had the drawback of fouling caused by, for example, the accumulation of particulates and organic matter, or the growth of a biofilm on the filter medium. The biofilm may be formed by natural organic matter, inorganic matter, and microorganisms accumulating on the surface or within the pores of the filter medium, causing fouling. The fouling of the filter medium may cause a reduction in flow rate or flux (i.e., flow rate per unit area) of water through the filter medium. Accordingly, as the filter medium fouls, the pressure (i.e., the differential pressure or the transmembrane pressure) that must be applied to force water through the filter medium at a given flow rate must be increased. However, there are limits to how high the pressure may be applied, for example, before causing damage to the filter medium. When the pressure reaches its upper limit, filtration must be suspended and the filter medium must be cleaned. Cleaning of the filter medium at least partially restores the flux through the filter medium. The decrease in flux through the filter medium caused by fouling and the required frequency to stop filtration and clean the filter medium results in an inefficient and expensive process.

Other conventional filter media used in water purification, including granular filters containing mono- or multimedia such as carbon, anthracite, sand and/or gravel, suffer many other drawbacks. For example, these media require huge quantities of material contained in large beds, and the expense and downtime for taking the filter offline for cleaning and/or replacing these media can be enormous.

Radiation, such as ultraviolet (UV) radiation, has been used in water treatment systems to sterilize water. However, many conventional radiation systems, such as those emitting radiation in only a narrow band or limited number of wavelengths, are limited in the types and number of organisms they can kill and organic matter they can oxidize.

Also, many conventional radiation systems, such as continuous UV radiation systems, are inefficient. For example, conventional UV lamps have a high maintenance cost because the lamps become fouled in the water environment from precipitated solids. This fouling action gradually reduces the UV output, so these lamps must be removed on a periodic basis and manually cleaned. Also, conventional low and medium pressure UV lamps may not produce the radiative power levels to effectively dissociate the chemical bonds of contaminants.

### SUMMARY OF THE INVENTION

In accordance with one aspect of the invention, a system for treating wastewater comprises an inlet for receiving wastewater; an outlet for discharging treated water; and at least one of a primary, secondary, and tertiary water treatment arrangement interposed between the inlet and the outlet of the wastewater treatment system. The system further comprises a first filter assembly having a filter medium interposed between the inlet and the outlet of the wastewater treatment system and a radiation assembly arranged to irradiate the water.

In accordance with another aspect of the invention, a method for treating wastewater comprises directing water through at least one of a primary, secondary, and tertiary water treatment arrangement; directing water through a first filter assembly having a filter medium; and irradiating the water.

In accordance with yet another aspect of the invention, a system for treating source water comprises an inlet for receiving source water and an outlet for discharging water. The system further comprises a filter assembly having a filter medium interposed between the inlet and the outlet of the source water purification system and a radiation assembly arranged to irradiate the water.

In accordance with a further aspect of the invention, a method for treating source water comprises directing water through a filter assembly having a filter medium and irradiating the water.

In accordance with another aspect of the invention, a method for treating water comprises directing water through a purification subsystem including removing contaminants to a desired level of purification during normal operating conditions; and then directing the water through a last-chance purification assembly which includes a filter assembly and a radiation assembly, including removing little or no contaminants during normal operating conditions and removing contaminants during abnormal conditions.

In accordance with another aspect of the invention, a system for treating water comprises a purification subsystem and a last-chance purifications assembly. The purification subsystem removes contaminants to a desired level of purification during normal operating conditions. The last-chance purification assembly includes a filter assembly and a radiation assembly and removes little or no contaminants during normal operating conditions but removes contaminants during abnormal conditions.

Systems and methods for treating wastewater, or source water, in accordance with one or more of the aspects of the invention may also have one or more of the following features.

The filter medium of the first filter assembly may be microporous or finer, may have a removal rating of 1μ or less, and/or may comprise a metallic or polymeric medium. The radiation assembly may be arranged to irradiate water upstream of the filter medium of the filter assembly. The radiation assembly may generate pulsed radiation and/or radiation having a broadband within the wavelength range from about 100 nm to about 1100 nm. For systems and methods which treat wastewater, a second filter assembly having a porous medium may be located downstream of the first filter assembly and the second filter assembly may comprise a reverse osmosis assembly. Further, a radiation assembly may be arranged to irradiate water upstream of the porous medium of the second filter assembly and downstream of the first filter assembly.

For systems and methods which treat wastewater, a last-chance purification assembly including an additional filter assembly and an additional radiation assembly may be located downstream of the first filter assembly.

For systems and methods which treat source water, a pretreatment arrangement, such as a prefilter assembly having a filter medium, may be located upstream of the filter assembly. Further, a radiation assembly may be arranged to irradiate water upstream of the filter medium of the prefilter assembly.

In various systems and methods embodying the invention, radiation, especially a pulsed, broadband radiation having wavelengths in the range from about 100 nm to about 1100 nm, in combination with a filter medium, especially a filter medium having a removal rating less than or equal to about 1μ, may be used to purify the water and/or enhance the flux of water through the filter medium. For example, the irradiation of wastewater or source water upstream of a microporous filter medium not only destroys any biological and chemical contaminants but also continuously cleans the filter medium, e.g., retarding or preventing the accumulation of organic matter and the development of a biofilm on the filter medium. As a result, fouling of the filter medium is reduced or prevented altogether, reducing or eliminating the need to stop filtration and clean or replace the filter medium. Because the radiation destroys organic matter and kills microorganisms such as viruses, bacteria, and protozoa such as Cryptosporidium and Giardia, and microporous filter media remove such microorganisms and natural organic matter, both components act in tandem to purify the water very effectively. Furthermore, the irradiation of source water and/or wastewater oxidizes certain inorganic substances, e.g., metals, such as iron, manganese, and arsenic to insoluble forms allowing them to be effectively removed using filtration. Thus, the combined use of a filter medium, particularly a filter medium which is microporous or finer, and radiation, particularly a pulsed, broadband radiation which includes wavelengths in the range from about 100 nm to about 1100 nm, provides a synergy which results in a far more efficient systems and methods than conventionally available.

Systems and methods embodying the invention may comprise a “last-chance” or “fail-safe” purification assembly which includes both a filter assembly and a radiation assembly. During normal operating conditions, the last-chance purification assembly may remove few, if any, contaminants because the portion of the wastewater or source water treatment system upstream of the last-chance purification assembly (i.e., the purification subsystem) has already removed the contaminants to the desired level of purification. However, during abnormal conditions, e.g., failure of one or more of the components of the purification subsystem or an abnormally high concentration of contaminants, the last-chance purification assembly removes a significant amount of the contaminants.

### BRIEF DESCRIPTION OF THE DRAWINGS

FIG. 1 illustrates a wastewater treatment system.

FIG. 2 illustrates a source water treatment system.

FIG. 3 illustrates a wastewater treatment system.

FIG. 4 illustrates a source water treatment.

### DETAILED DESCRIPTION

The present invention relates to the use of radiation and filtration in the purification of water. Purification of water preferably includes removing undesired substances or contaminants, including but not limited to particulates; various biological substances, such as bacteria and/or protozoa, e.g., Cryptosporidium and Giardia, or viruses; and various chemical substances, such as harmful or noxious chemical elements and compounds, including various inorganic substances, e.g., metals such as iron, manganese, and arsenic and various organic compounds. The present invention may preferably be used to treat wastewater, such as industrial wastewater or municipal wastewater, or source water, such as industrial source water or municipal drinking water.

Embodiments of the invention include systems and methods for treating wastewater, so that the purified water may be suitable for drinking or may be reused for other non-drinking purposes. Wastewater may include any type of water which has been used and is no longer suitable for its intended purpose in its present form. For example, wastewater may include, but is not limited to, municipal wastewater, such as sewage, or industrial wastewater, such as effluent from an industrial process.

One example of a method includes treating a wastewater influent by passing it through at least one of a primary, secondary, and tertiary water treatment arrangement and irradiating the water, preferably upstream of a filter assembly. Irradiating water upstream of the filter assembly purifies the water and increases the flux of water through the filter medium in the filter assembly.

One example of a system for treating wastewater includes an inlet for untreated wastewater and an outlet for purified water. At least one of a primary, secondary, and tertiary water treatment arrangement, e.g., a secondary water treatment arrangement and one or both of a primary and a tertiary water treatment arrangement, may be interposed between the inlet and the outlet of the wastewater treatment system. A first filter assembly having a filter medium may be interposed between the inlet and the outlet of the wastewater treatment system. A radiation assembly may be arranged to irradiate water, preferably upstream of the filter medium. A second filter assembly, for example, a reverse osmosis assembly, may be located downstream from the first filter assembly.

“Primary water treatment”, “secondary water treatment”, and “tertiary water treatment” arrangements are well known in the wastewater treatment field. For example, a primary water treatment arrangement may include, but is not limited to, an arrangement such as a screening or a sedimentation arrangement which removes floating material and/or settleable solids from the wastewater. A secondary water treatment arrangement may include, but is not limited to, an arrangement having biological and/or chemical treatment units which remove organic matter from the wastewater. For example, a secondary water treatment arrangement may include a primary clarifier, a biotreatment unit, such as an activated sludge basin, and a final clarifier. A tertiary water treatment arrangement may include, but is not limited to, an arrangement such as a granular filtration arrangement which removes particulate matter and BOD (Biological Oxygen Demand) and, if the granular filtration arrangement is chemically and/or biologically treated, nutrients such as phosphorous or nitrogen from the water. A tertiary water treatment arrangement may also include, but is not limited to, a continuous sand filter. Any of the water treatment arrangements may be configured in a wide variety of ways. Examples of suitable arrangements include a batch arrangement with an open loop, a batch arrangement with a closed loop, a single-stage continuous arrangement, a multistaged arrangement with recirculation, and a multistaged arrangement without recirculation, as described, for example, in Water Treatment Membrane Processes, American Water Works Association Research Foundation et al., September 1996, pages 2.22-2.24.

The inlet of the wastewater treatment system may be any suitable arrangement for allowing untreated water to travel to the other components of the system. For example, the inlet may include a conduit, pipe, or manifold which is in fluid communication with, e.g., delivers wastewater to, for example, the primary and/or secondary water treatment arrangement. The inlet of the wastewater treatment system may be connected directly or indirectly to the inlet of the primary or secondary water treatment arrangement. Similarly, the outlet for treated or purified water may be any suitable arrangement allowing the purified water to exit the wastewater treatment system. For example, the outlet may include a conduit, pipe, or manifold which is in fluid communication with, e.g., receives purified water from, the filter assemblies. The outlet of the wastewater treatment system may be connected directly or indirectly to the outlet of the first or second filter assembly.

The first filter assembly may include an inlet for water to be treated, an outlet for filtrate or permeate, and a filter medium, e.g., one or more filter elements, each including a filter medium, disposed in a fluid flow path between the inlet and outlet. The inlet of the first filter assembly may, for example, be coupled to or be in fluid communication with an outlet of the secondary water treatment arrangement or an outlet of a tertiary water treatment arrangement.

The type of filter assembly utilized in the invention is not particularly limited. For example, a dead-end filter assembly or a cross-flow filter assembly may be used. The filter assembly may be configured in a wide variety of ways. For example, the filter assembly may be configured as a plate-and-frame or stacked plate filter assembly, a dynamic filter assembly, or a granular bed filter assembly. Preferably, the filter assembly is configured as an array of filter cartridges or filter modules.

Various types of filter elements may be used with the present invention. For example, the filter element or filter elements may comprise filter media in flat sheet form, e.g., as a fibrous sheet, a sintered metal plate, or a permeable or semipermeable film. Alternatively, the filter element may be configured as a cylindrical element, e.g., a ceramic candle filter, a cylindrical hollow or solid fibrous mass, or a hollow pleated configuration, such as a straight, radial pleat design or a non-radial configuration, as disclosed, e.g., in U.S. Pat. No. 5,543,047 and U.S. Pat. No. 6,113,784. The flow through the filter element may be outside-in, where water initially contacts the outside surface(s) of a filter element, with filtrate or permeate passing through the filter medium to the inside surface(s) of the filter element. Alternatively, the flow through the filter element may be inside-out, where the water initially contacts the inside surface(s) of a filter element, with filtrate or permeate passing through the filter medium to the outside surface(s) of the filter element. Also, the filter element may comprise a composite including a filter medium or filter media and additional layers that are in fluid communication with the filter medium or media, including support and/or drainage layers and/or cushioning layers. Other suitable configurations include spiral or tubular modules. Preferably, the filter elements comprise disposable or cleanable filter cartridges and, more preferably, hollow fiber filter modules.

Various types of filter media may be used in the first filter assembly. The filter media used in the filter element may include any material capable of forming a porous structure suitable for purifying water by removing particles, such as solids, gels, or microbes, and/or by removing or inactivating chemical substances, such as ions or organic or inorganic compounds. The filter media may include porous inorganic media, mono- or multi-component granular media such as sand, anthracite, garnet and/or carbon, porous metal media, porous ceramic media, porous mineral media, porous media comprising organic and/or inorganic fibers such as carbon and/or glass fiber media, and/or porous polymeric media. The filter media may include fibrous media such as a mass of fibers, fibrous mats, woven or non-woven sheets, and fibrous depth filters made by a variety of means including melt-blowing, Fourdrinier deposition, or air laying fibrous materials. The filter medium may include a porous or semipermeable film or membrane, e.g., isotropic or anisotropic, asymmetric, composite, supported or unsupported membranes. The filter media may include hollow fibers, such as polymeric hollow fibers. The filter media, especially the granular media, may include chemically, catalytically, and/or physically active media, such as various resins, e.g., ion exchange resins, such as water softeners or demineralizers, zeolites, various “activated” forms of carbon, e.g., granular activated carbon, sorbents, catalysts, getters and/or biocides.

Preferably, the filter medium comprises any suitable metallic or polymeric medium. Even more preferably, the filter medium comprises a polymeric medium, such as polyvinylidene fluoride (PVDF) or polyacrylonitrile (PAN). Other suitable polymeric filter media that may be used in the present invention include polyethersulfone (PES), polysulfone (PS), polytetrafluoroethylene (PTFE), and polycarbonate (PC).

Porous filter media having a wide variety of pore sizes or structures or removal ratings may be used with the present invention. The pore size or removal rating used depends on the composition of the water to be purified and the desired purity level of the water. Preferably, the filter medium is, at most, microporous. More preferably, the removal rating of the filter medium is small enough to capture particulates and microorganisms such as bacteria and/or protozoa, such as Cryptosporidium and Giardia, or viruses. Microporous and ultraporous media are preferred, although nanofiltration membranes may be used. The removal rating of the filter medium may be about 1 micron or less, preferably about 0.5 micron or less, more preferably about 0.2 micron or less, and even more preferably about 0.1 micron or less. Most preferably, the filter medium is microporous and has a removal rating in the range from about 0.05μ to about 1μ.

In a preferred embodiment, the first filter assembly comprises a hollow fiber membrane module, the hollow fiber membranes being made of PVDF and having a removal rating of about 0.1 micron, available from Pall Corporation under the trade designation Microza. In another embodiment, also available from Pall Corporation under the trade designation Microza, the first filter assembly may comprise ultraporous hollow fiber membranes being made of PAN and having a nominal molecular weight cutoff (MWCO) in the range from about 13,000 or less to about 80,000 or more. For both the microporous and the ultraporous hollow fiber modules, fluid flow during filtration is preferably outside-in, where water initially contacts the outside surface(s) of the hollow fibers, passes through to the interior of the hollow fibers, and is directed to a suitable permeate outlet.

The second filter assembly includes a porous medium which is preferably finer than the filter medium of the first filter assembly. For example, the second filter assembly preferably comprises a reverse osmosis assembly, which is well known in the art. The second filter assembly is preferably located downstream from the first filter assembly and includes an inlet which may be coupled directly or indirectly to the outlet of the first filter assembly and a permeate outlet which may be coupled directly or indirectly to the outlet of the wastewater purification system. The second filter assembly may further include a retentate outlet which may be coupled to any of the previous components of the wastewater purification system to recirculate the retentate or may be coupled to a water reservoir or river to discharge the retentate.

The radiation assembly may generate radiation which destroys and/or alters water borne biological and/or chemical contaminants, such as bacteria, viruses, organic compounds, and inorganic matter in the wastewater. The radiation assembly may destroy and/or alter the contaminants directly, e.g., by directing the radiation into the water and/or onto the filter media where the radiation is absorbed by the biological and/or chemical contaminants, destroying or altering them. Alternatively or additionally, the radiation assembly may destroy and/or alter the contaminants indirectly, e.g., by directing the radiation onto the surface of a photoactive material in contact with the water and/or the filter media where the radiation is absorbed by the photoactive material, activating it. The biological and/or chemical contaminants are then destroyed and/or altered when they contact the activated photoactive material. A radiation assembly which destroys and/or alters the contaminants directly may principally include a radiation source, while a radiation assembly which destroys and/or alters the contaminants indirectly may principally include a radiation source and a photoactive unit. The photoactive unit may include a photoactive material and a vessel which contains the photoactive material and may also contain the radiation source. Suitable photoactive materials include, for example, metal oxides, such as TiO₂, ZnO, WO₃, SnO₂, Cu₂O and CdS and CdSe. The vessel may be configured in a wide variety of ways. Preferably, the vessel is designed to provide uniform fluid flow with few or no dead spaces and small residence time and/or adequate irradiation of all fluid and/or all photoactive material. Radiation assemblies which include a radiation source or a radiation source and a photoactive material are shown, for example, in U.S. Pat. No. 4,464,336; No. 4,615,799; No. 4,694,179; No. 4,892,712; No. 5,302,356; No. 5,658,530; No. 5,790,934; and No. 5,789,755, all of which are incorporated by reference.

The radiation assembly may be arranged to irradiate the water, i.e., irradiate the water directly and/or irradiate a photoactive material in contact with the water, upstream of the filter medium of the first filter assembly, where “upstream of the filter medium” includes in, on, or upstream of the filter medium. For example, one or more radiation assemblies may be positioned so that water and/or photoactive material upstream of a filter medium, e.g., a microporous filter medium, of the first filter assembly or upstream of the inlet of the first filter assembly is irradiated by the radiation source(s). More preferably, the radiation assembly is arranged to directly or indirectly irradiate the water upstream of the inlet of the first filter assembly but downstream of the outlet of the secondary or tertiary water treatment subsystem. Alternatively or additionally, one or more radiation assemblies may be positioned to irradiate the water by irradiating the upstream surface of the filter medium so that water and/or photoactive material at the upstream surface of the filter medium is exposed to the radiation. For example, the radiation source(s) may direct radiation directly onto the upstream surface of the filter medium or the radiation sources may direct radiation from the downstream surface(s) through the filter medium onto the upstream surface(s). In embodiments where the surfaces of the filter medium are irradiated, the filter medium is even further cleaned of any biofilm by killing of organisms and oxidation of organic matter on the surfaces of the filter medium.

Alternatively or additionally, if the first filter assembly has a retentate outlet, e.g., is a cross-flow filter assembly, the radiation assembly may be arranged to irradiate water in the retentate that is recirculated back upstream of the filter medium. Alternatively or additionally, the radiation assembly may be arranged to irradiate water at the intersection of the retentate and the upstream water and/or after mixing the retentate and the upstream water.

Similarly, one or more radiation assemblies may also be arranged to irradiate water downstream of the first filter assembly and upstream of the second filter assembly. The radiation assemblies may be positioned to irradiate water upstream of the porous medium of the second filter assembly in a manner analogous to that previously described with respect to the filter medium of the first filter assembly.

The radiation assembly purifies the water and/or enhances the flux of water through the filter medium and/or porous medium by destroying or altering contaminants and/or reducing or eliminating any biofilm associated with the filter medium and/or porous medium. The radiation source may generate radiation having any wavelength that is effective in killing microorganisms and/or oxidizing organic matter. The radiation source may also generate radiation having any wavelength that is effective in oxidizing, or promoting the oxidation of, inorganic matter, including metals such as iron, manganese and arsenic. The oxidized inorganic matter may assume a more insoluble form, allowing it to be more effectively removed by filtration.

The radiation source may preferably be capable of generating radiation having one or more wavelengths in the range from about 100 nanometers to about 1100 nanometers. Preferably, the radiation source generates radiation having a broadband within the range from about 100 nm to about 1100 nm, i.e., having a distribution of wavelengths, e.g., most or substantially all of the wavelengths, within any subband extending for at least 20%, preferably at least 35%, and more preferably at least 50% or at least 80% of the range. For example, the broadband may comprise a distribution of wavelengths within a UV subband from about 100 nm to about 400 nm, e.g., a subband from about 185 nm to about 400 nm, a visible subband from about 400 nm to about 700 nm, and/or an infrared subband from about 700 nm to about 1100 nm. Alternatively, the radiation source may be capable of generating narrower band radiation, e.g., radiation within a narrower subrange, such as, for example, about 100 nm to about 200 nm (Vacuum Ultraviolet), about 200 nm to about 280 nm (UVC), about 280 nm to about 315 nm (UVB), and/or about 315 nm to about 400 nm (UVA). The radiation source may also be capable of generating more discrete wavelengths of radiation. For example, the radiation source may be capable of generating radiation with a nominal emission at 253.7 nm, which is an effective wavelength in inactivating microorganisms.

The radiation source may be capable of emitting a continuous stream of radiation. However, in a preferred embodiment, the radiation source is capable of delivering pulses of radiation in short bursts. A pulsed radiation source is more energy efficient and is capable of delivering high intensity radiation to kill microorganisms in water, purifying the water and enabling enhanced flux across the filter media. Most preferably, the radiation source is capable of delivering pulsed, broadband, blackbody radiation, as described, for example, in U.S. Pat. No. 5,789,755, herein incorporated by reference. Such pulsed, broadband, blackbody radiation assemblies are available from Pulsar Remediation Technologies, Inc.

One example of a method of purifying wastewater may comprise directing wastewater through at least one of a primary, secondary, and tertiary water treatment arrangement, e.g., a secondary water treatment arrangement and one or both of a primary and tertiary water treatment arrangement, and irradiating water upstream of a filter medium with a radiation source. Irradiating the water includes both directly and indirectly radiating the biological and/or chemical contaminants, e.g., by radiating the contaminants in the water and by radiating a photoactive material to activate the photoactive material and contacting contaminants in the water with the activated photoactive material. The method may further comprise directing the irradiated water through a first filter assembly, e.g., a microporous filter assembly, and a second filter assembly, e.g., a reverse osmosis assembly. The irradiation of the water upstream of the first filter assembly further purifies the water and enhances the flux of the water through the filter medium.

Preferably, the water is directed to a first filter assembly downstream of the secondary or tertiary water treatment arrangement. The first filter assembly may have any suitable configuration, as previously described for the wastewater purification system. For example, the filter assembly may comprise a filter medium having a removal rating of about 1 micron or less, e.g., 0.1μ or less, and preferably comprises a microporous filter medium having a removal rating in the range from about 0.05μ to about 1μ. After exiting the secondary or tertiary water treatment arrangement, the water may enter the inlet of the first filter assembly and may be directed from the upstream surface(s) of the filter element(s), through the filter medium, forming a filtrate or permeate, to the downstream surface(s) of the filter element(s). Contaminants such as particulates and organisms are prevented from passing through the filter medium, while the filtrate or permeate exits through the outlet of the first filter assembly.

The differential pressure or transmembrane pressure that may be applied across the filter medium depends upon several factors, such as the nature of the filter system, the desired flow rate, and the degree of fouling of the filter medium. For example, water may be directed through a Microza 0.1μ hollow fiber filter module up to a transmembrane pressure of about 25-28 psid or more but preferably less than about 36 psid.

In many preferred embodiments, the water may be directed to the first filter assembly immediately after exiting the secondary treatment arrangement or immediately after exiting the tertiary water treatment arrangement. Alternatively, after exiting the secondary or tertiary water treatment arrangement, the water may undergo additional treatment before being directed into the first filter assembly. As a further alternative, the water may be directed into the first filter assembly while undergoing treatment in the secondary or tertiary water treatment arrangement.

After exiting the first filter assembly, the filtrate or permeate may be directed to the porous medium of the second filter assembly, for example, an RO membrane of a reverse osmosis assembly as previously described. Water may be directed into the second filter assembly immediately after exiting the first filter assembly or the water may be further treated after exiting the first filter assembly and before entering the second filter assembly. Once in the second filter assembly, the water may be directed from the upstream surface of the porous medium, through the porous medium, and to the downstream surface of the porous medium, while various dissolved chemical substances, such as dissolved solids, salts and organic compounds, are retained by the porous medium. Permeate exiting the porous medium may be further treated, may be distributed as drinking water, and/or may be used for other non-drinking purposes, such as in an industrial process, e.g., as the production of ultra pure water in microelectronics manufacturing.

Prior to passing through the filter medium of the first filter assembly, the water is irradiated. For example, if the water has passed through the secondary or tertiary water treatment arrangement, it may be irradiated prior to passing through the filter medium with an amount of radiation that is sufficient to further purify the water and/or enhance the flux of water through the filter medium. The amount of irradiation required depends upon, for example, the amount of biological and/or chemical contaminants in the water, the degree of purification desired, and the desired flux and/or pressure drop or transmembrane pressure through the first filter assembly. For example, the flow rate of the water may be in the range from about 50 gallons of water per minute or less to as much as about 20 million gallons of water per day or more.

As described above, the wastewater may be irradiated in a variety of ways. For example, the water may be irradiated directly, i.e., by directing the radiation from a radiation source into the water itself, where the radiation is absorbed by the biological and/or chemical contaminants, destroying them. Alternatively or additionally, the water may be irradiated indirectly, e.g., by directing the radiation onto a photoactive material, which activates the photoactive material, and contacting the photoactivated material with the biological and/or chemical contaminants, destroying them. The water may be irradiated upstream of the first filter assembly or within the first filter assembly. For example, the radiation may be directed from the radiation source onto the upstream surface of the filter medium, or the radiation may be directed at the downstream surface of the filter medium, through the filter medium, to the upstream surface of the filter medium and the water upstream of the filter medium.

In various embodiments, water downstream of the first filter assembly may also be irradiated. For example, water downstream of the first filter assembly and upstream of the second filter assembly may be irradiated, as well as water downstream of the second filter assembly. Also, water undergoing treatment in the primary, secondary, and/or tertiary water treatment arrangements may be irradiated in any suitable manner.

Because irradiating the water reduces or prevents fouling of the filter/porous medium, e.g., by decreasing the biofilm and/or destroying microbes, the flux of water through the filter/porous medium may be increased for a given differential pressure or transmembrane pressure. Or, the differential pressure or transmembrane pressure that may be applied during filtration may be lower and may increase more slowly, if at all, to maintain a given flux of water through the filter/porous medium. As a result, the upper limit for the differential pressure or the transmembrane pressure may be reached more slowly, if at all. Accordingly, not only may the flux of water be increased but also filtration may be performed for longer periods of time before stopping to clean or replace the filter/porous medium, if cleaning is required at all.

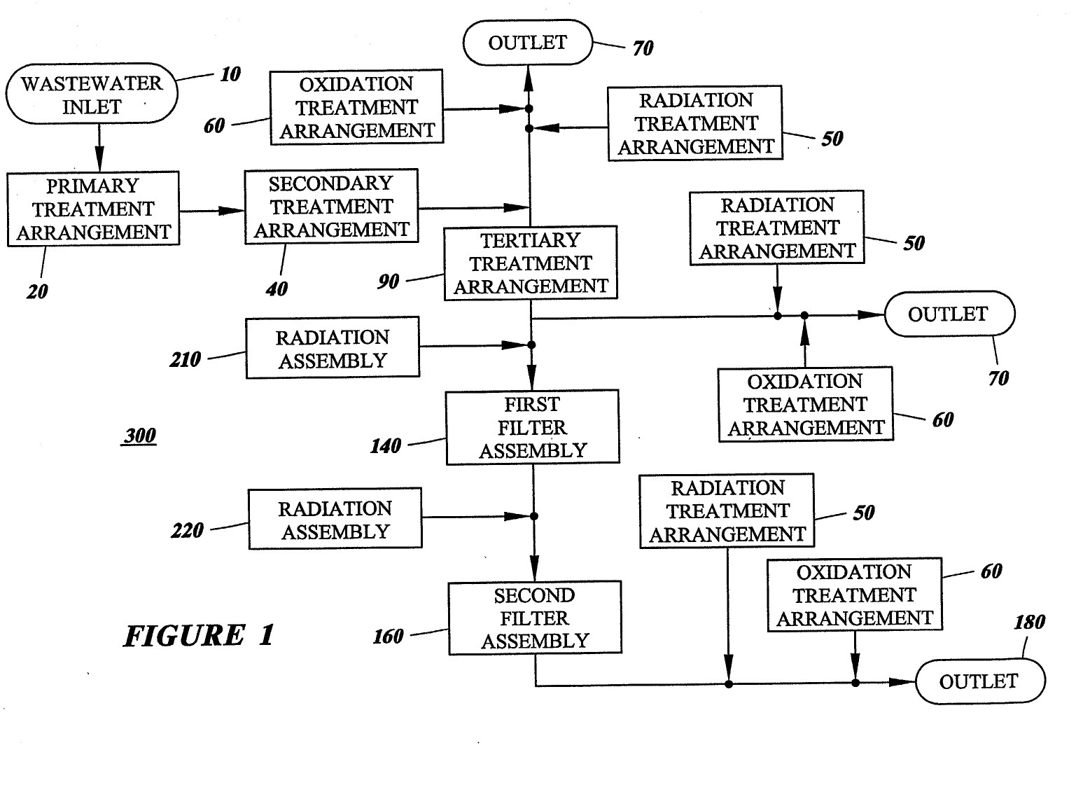

FIG. 1 illustrates one example of an embodiment of a wastewater treatment system 300 and method. Untreated wastewater enters via an inlet 10 of the wastewater treatment system upstream of a primary water treatment arrangement 20 and passes through the primary water treatment arrangement 20, e.g., a screening unit and/or a sedimentation basin. The water downstream of the primary treatment arrangement 20 enters a secondary water treatment arrangement 40, and passes through the secondary water treatment arrangement 40, e.g., a biotreatment unit and a secondary clarifier. Some or none of the water downstream of the secondary water treatment arrangement 40 may be directed toward an outlet 70, e.g., a river or a reservoir. Prior to being discharged into the river or reservoir, the water may be further treated, for example, by radiation 50 or oxidation 60, e.g., by the addition of agents such as chlorine (Cl₂), chlorine dioxide (ClO₂), ozone or hydrogen peroxide in any conventional manner.

Alternatively or additionally, water downstream of the secondary water treatment arrangement 40 may be directed to a tertiary water treatment arrangement 90 such as a granular bed filter assembly including a sand and/or anthracite bed 90. The water passes through the sand and/or anthracite bed 90, and some, or none, of the water downstream of the sand and/or anthracite bed 90 may be directed toward the outlet 70, e.g., a river or a reservoir. Again, prior to being discharged, the water may be further treated, for example, by radiation 50 or oxidation 60.

Water downstream of the tertiary water treatment arrangement 90 is directed to the first filter assembly 140, e.g., a microfiltration assembly. Preferably, the first filter assembly 140 comprises cleanable and/or replaceable filter cartridges or filter modules, such as the Microza filter modules previously described. Water passes through the filter medium of the first filter assembly 140, producing filtered water as a filtrate or permeate, and any retentate (not shown) may be recirculated to any of the components of the wastewater purification system or discharged into the river or reservoir.

The filtered water may then be directed to a second filter assembly 160, e.g., a reverse osmosis assembly. Water passes through the porous medium of the second filter assembly 160 producing purified water as a permeate, and any retentate (not shown) may be recirculated to any of the components of the wastewater purification system or may be discharged into the river or reservoir.

Upstream of the filter medium of the first filter assembly 140, a radiation assembly 210 irradiates the water. Preferably, the radiation assembly 210 is arranged to irradiate the water upstream of the inlet of the first filter assembly 140 and more preferably immediately prior to entering the first filter assembly 140, but downstream of the secondary water treatment arrangement 40, e.g., downstream of the tertiary water treatment arrangement 90. However, the radiation assembly may be arranged to irradiate the water within the first filter assembly upstream of the filter medium. While the radiation assembly may comprise a radiation source and a photoactive unit, the radiation assembly preferably comprises a radiation source without a photoactive unit which directly irradiates the water. For example, the radiation assembly may comprise a pulsed, broadband, blackbody radiation unit available from Pulsar Remediation Technologies, Inc. as previously described. The radiation assembly destroys water borne biological and/or chemical contaminants which might otherwise contact the filter medium of the first filter assembly, thereby further purifying the water and enhancing the flux through the filter medium of the first filter assembly 140.

Preferably, a radiation assembly 220 also irradiates the water upstream of the porous medium of the second filter assembly 160. The radiation assembly 220 may be located within the second filter assembly 160 but is preferably located downstream of the first filter assembly 140 and upstream of the second filter assembly 160. The radiation assembly 220 associated with the second filter assembly 160, which may be similar or identical to the radiation assembly associated with the first filter assembly 140, serves to destroy water borne biological and/or chemical contaminants which might otherwise contact the medium of the second filter assembly 160, thereby further purifying the water and enhancing the flux through the porous medium of the second filter assembly 160.

Water which passes through the porous medium of the second filter assembly 160 may be discharged via an outlet 180 of the wastewater treatment system 300 and used as drinking water or used for other non-drinking purposes. Prior to being discharged, the water may be further treated, for example, by radiation 50 and/or oxidation 60.

As previously described, for many embodiments of the invention, the first filter assembly and the associated radiation assembly may serve to remove contaminants from the water that are not sufficiently removed by the primary, secondary, and/or tertiary water treatment arrangements during normal operation. The second filter assembly and the associated radiation assembly may then serve to further purify the water. However, the invention is not limited to these embodiments. For some embodiments of the invention, the first filter assembly and the associated radiation assembly may serve as a last-chance or fail-safe purifier which removes little or no contamination from the water during normal operation. The primary, secondary and/or tertiary water treatment arrangements may remove all or a sufficient quantity of the contaminants during normal operation to provide a desired level of purity. The first filter assembly and the associated radiation assembly may then provide little or no further purification as the water flows through the first_filter assembly and the radiation assembly during normal operation. However, during abnormal conditions, e.g., when one or more of the components of the primary, secondary, and/or tertiary water treatment arrangements malfunctions or when an abnormally high concentration of contaminants swamps the primary, secondary, and/or tertiary water treatment arrangement, the first filter assembly and the associated radiation assembly may comprise a last-chance or fail-safe purifier assembly which removes the contaminants that passed through the primary, secondary, and/or tertiary water treatment arrangements. For those embodiments in which the first filter assembly and the associated radiation assembly_serve as a last-chance or fail-safe purifier, the second filter assembly and the associated radiation assembly are less preferred and may be eliminated.

Embodiments of the invention also include systems and methods for treating source water, so that the purified water may be suitable for drinking or reusable for other non-drinking purposes. Source water may include any water which is to be supplied or distributed. For example, source water may include, and is not limited to, municipal source water or industrial source water. Source water may include surface water, such as water from a river or a reservoir, or groundwater. Source water may even include treated wastewater which has, for example, been purified after industrial use.

One example of a method for treating source water includes treating a source water influent by irradiating the source water and passing the water through a filter assembly. For example, the water may be irradiated upstream of a filter assembly comprising a filter medium which is preferably, at most microporous, e.g., is microporous or ultraporous or nanoporous. Irradiating the source water upstream of the filter assembly purifies the water and enhances the flux of water through the filter medium.

One example of a system for treating source water includes an inlet for untreated source water and an outlet for purified water. A filter assembly having a filter medium, or both a pretreatment arrangement, such as a prefilter assembly, and a filter assembly, may be interposed between the inlet and the outlet of the source water purification system. A radiation assembly is arranged to irradiate water, preferably upstream of the filter medium of the filter assembly.

The inlet for the source water treatment system may be any suitable arrangement for allowing untreated or insufficiently treated source water to travel to the other components of the system. For example, the inlet may include a conduit, pipe, or manifold which is in fluid communication with, e.g., delivers source water to, for example, the prefilter assembly and/or the filter assembly. The inlet of the source water treatment system may be connected directly or indirectly to the inlet of the prefilter assembly or the filter assembly. Similarly, the outlet for treated or purified source water may be any suitable arrangement allowing the purified source water to exit the source water treatment system. For example, the outlet may be a conduit, pipe, or manifold in fluid communication with the filter assembly.

The pretreatment arrangement preferably comprises a prefilter assembly but may alternatively or additionally comprise a variety of devices for pretreating the source water, such as a settling basin or a floatation tank. The prefilter assembly may include an inlet for water to be treated and an outlet for filtrate or permeate and may be interposed between the inlet and the outlet of the source water treatment system upstream of the filter assembly. The prefilter assembly may have any suitable configuration and any suitable filter medium for removing larger particles and/or organisms so that the downstream filter assembly may not foul as quickly, or at all. The removal rating of the filter medium of the prefilter assembly is not particularly limited but is larger than that of the downstream filter assembly. For example, the removal rating of the prefilter may be up to about 10 microns or larger, for example, up to about 50 microns or larger or up to about 100 microns or larger or up to about 400 microns or even larger. In one embodiment, the filter medium of the prefilter assembly may have a removal rating of about 400 microns and may comprise a disposable strainer.

The filter assembly is also interposed between the inlet and the outlet of the source water treatment system. In many embodiments, the filter assembly may be located downstream of the pretreatment arrangements(s), e.g., the prefilter assembly. The filter assembly may include an inlet for receiving water to be treated, for example, from the outlet of the prefilter assembly or the inlet of the source water purification assembly. In some embodiments, the water may be additionally treated in a variety of ways between the inlet of the source water purification system and the inlet of the filter assembly. The filter assembly also includes an outlet for discharging filtered water as permeate or filtrate. The outlet of the filter assembly may be coupled directly or indirectly to the outlet of the source water purification system. The filter assembly further includes a filter medium disposed in the flow path between the inlet and the outlet.

The filter assembly of the source water treatment system may have many of the same features as the first filter assembly of the wastewater treatment system. For example, it may have any of the types, configurations, filter media, and/or pore sizes/structures/removal ratings described above for the first filter assembly of the wastewater treatment system. Thus, the filter assembly of the source water purification system may be a dead-end filter or a cross flow filter and may be configured, for example, as a granular bed filter or an array of filter cartridges or filter modules, as previously described. The filter media may include mono- or multi-component granular media such as sand, anthracite, garnet and/or carbon, porous inorganic or organic media, such as porous metal or polymeric media, or fibrous media, porous or semipermeable films, or porous hollow fibers. The filter media, especially the granular media, may alternatively or additionally include chemically, catalytically, and/or physically active media, such as various resins, e.g., ion exchange resins, water softeners, or demineralizers, various “activated” forms of carbon, sorbents, getters, and/or biocides, all as previously described.

A variety of pore sizes/structures/removal ratings may be used with the present invention. Preferably, the filter medium is microporous or finer, e.g., is microporous or ultraporous or nanoporous. In a more preferred embodiment, the filter assembly comprises a microporous filter medium having a removal rating of about 1 micron or less. Preferably, the removal rating of the filter medium is about 0.5 micron or less and, more preferably, about 0.1 micron or less. A filter medium having a removal rating of about 0.1 micron or less is particularly preferred in the source water treatment system because it has been found to be especially effective in trapping particulates and organisms, such as Cryptosporidium and Giardia, especially when used in conjunction with a radiation source, as discussed below.

In a preferred embodiment, the filter assembly comprises one or more microporous hollow fiber membrane modules, each hollow fiber membrane having a removal rating of about 0.1 micron, available from Pall Corporation under the trade designation Microza. In another embodiment, also available from Pall Corporation under the trade designation Microza, the first filter assembly comprises one or more membrane modules including an ultraporous hollow fiber membrane having a nominal molecular weight cutoff (MWCO) in the range from about 13,000 or less to about 80,000 or more. For both the microporous and the ultraporous hollow fiber embodiments, fluid flow for filtration may be outside-in, where water may initially contact the outside surface(s) of the hollow fibers, pass through to the interior of the hollow fibers, and be directed to a suitable outlet.

The radiation assembly generates radiation which destroys or alters water borne biological and/or chemical contaminants, such as bacteria, viruses, organic compounds, and inorganic matter in the source water. The radiation assembly may be substantially similar in both function and structure to the radiation assembly described with respect to the wastewater treatment system. Thus, the radiation assembly may destroy or alter contaminants directly or indirectly, may include a radiation source or a radiation source and a photoactive material, and may generate pulsed or continuous, broadband or narrower band, blackbody radiation, as previously described. Preferably, the radiation assembly comprises a pulsed, broadband, blackbody radiation source which generates radiation having a broadband within the range of wavelengths from about 100 nm to about 1100 nm, as described in U.S. Pat. No. 5,789,755 and available from Pulsar Remediation Technologies, Inc.

The radiation assembly may be arranged to irradiate

the water, i.e., irradiate the water directly and/or irradiate a photoactive material in contact with the water, upstream of the filter medium of the filter assembly, where “upstream of the filter medium” includes in, on, or upstream of the filter medium. For example, one or more radiation assemblies may be positioned so that water and/or photoactive material upstream of the inlet of the first filter assembly is irradiated by the radiation source(s). Preferably, the radiation assembly is arranged to directly or indirectly irradiate the water upstream of the inlet of the filter assembly but downstream of the outlet of the prefilter assembly. Alternatively or additionally, one or more radiation assemblies may be positioned to irradiate the water by irradiating the upstream surface of the filter medium so that water and/or photoactive material at the upstream surface of the filter medium is exposed to radiation. For example, the radiation source(s) may direct radiation directly onto the upstream surface of the filter medium, or the radiation source(s) may direct radiation from the downstream surface(s) through the filter medium to the upstream surface(s).

Alternatively or additionally, if the filter assembly has a retentate outlet, e.g., is a cross-flow filter assembly, the radiation assembly may be arranged to irradiate water in the retentate that is recirculated back upstream of the filter medium. Alternatively or additionally, the radiation assembly may be arranged to irradiate water at the intersection of the retentate and the upstream water and/or after the intersection of the retentate and the upstream water.

A radiation assembly may be arranged to irradiate water at a variety of other locations. In some embodiments, a radiation assembly may be arranged to irradiate filtered water downstream of the filter assembly. In some embodiments, a radiation assembly may be positioned so that source water upstream of the filter medium of the prefilter assembly may be irradiated. As discussed above, the radiation source(s) may be positioned to directly or indirectly irradiate the water upstream of the filter medium of the prefilter assembly or upstream of the inlet to the prefilter assembly.

One example of a method for treating source water may comprise irradiating water and passing water through a porous filter medium, e.g., a filter medium which is at most microporous. Source water from, for example, a municipal water source or an industrial process water source may be directed into an inlet of the source water treatment system and, preferably, through a pretreatment arrangement such as a prefilter assembly as described above. The source water may enter the inlet of the prefilter assembly and pass through the filter medium of the prefilter assembly, while larger particulates are retained by the filter medium. The prefiltered water then exits the prefilter assembly through the outlet and may then be directed to the filter assembly.

Water enters the filter assembly through the inlet and is directed to the filter medium. While the filter assembly may have any suitable configuration, as previously described, it preferably includes a filter medium having a removal rating of about 1 micron or less, e.g., about 0.0μ or less. The water passes from the upstream surface(s) of the filter element or medium, through the filter medium, forming a filtrate or permeate, to the downstream surface(s) of the filter element or medium. Contaminants, such as organisms and particulates, are retained by the filter medium, while the filtrate or permeate exits through the outlet of the filter assembly, all as similarly described with respect to the first filter assembly of the wastewater purification system. Retentate, if any, may be recirculated to the source or to any of the other components of the source water treatment system. The filtrate or permeate exiting the filter assembly may be further treated, may be distributed as drinking water, and/or may be used for other non-drinking purposes, such as in an industrial process, e.g., as ultrapure water in microelectronics manufacturing.

Prior to passing the filter medium of the filter assembly, the water is irradiated. The water may be irradiated in a variety of ways, as previously discussed with respect to the wastewater treatment system. For example, the water may be irradiated directly, i.e., by directing the radiation into the water itself, where the radiation is absorbed by the contaminants themselves, destroying them. Alternatively or additionally, the water may be irradiated indirectly, i.e., by directing the radiation onto a photoactive material, which activates the photoactive material, and contacting the photoactivated material with the contaminants, destroying them. The water may be irradiated upstream of the filter assembly or within the filter assembly upstream of the filter medium. In a preferred embodiment, the water is directly irradiated downstream of the prefilter assembly and upstream of the filter assembly with a pulsed, broadband, blackbody radiation of the type described in U.S. Pat. No. 5,789,755 and available from Pulsar Remediation Technologies, Inc. The amount of radiation depends on, for example, the amount of the contaminants, the degree of purification desired, and the desired flux and/or pressure drop and transmembrane pressure through the filter medium. Generally, the amount of radiation is preferably sufficient to further purify the water and/or enhance the flux of water through the filter medium, e.g., by reducing the biofilm and/or destroying or altering organisms on the filter medium.

In various embodiments, filtrate or permeate downstream of the filter medium and/or retentate from the filter assembly may be irradiated. Further, while the water may be irradiated only once, e.g., upstream of the filter assembly and downstream of the prefilter assembly or upstream of both the filter assembly and the prefilter assembly, the water is preferably irradiated at least twice: both upstream of the filter medium of the filter assembly and upstream of the filter medium of the prefilter assembly. Irradiating the water upstream of the filter medium of the prefilter assembly further purifies the water and/or enhances the flux through the prefilter assembly.

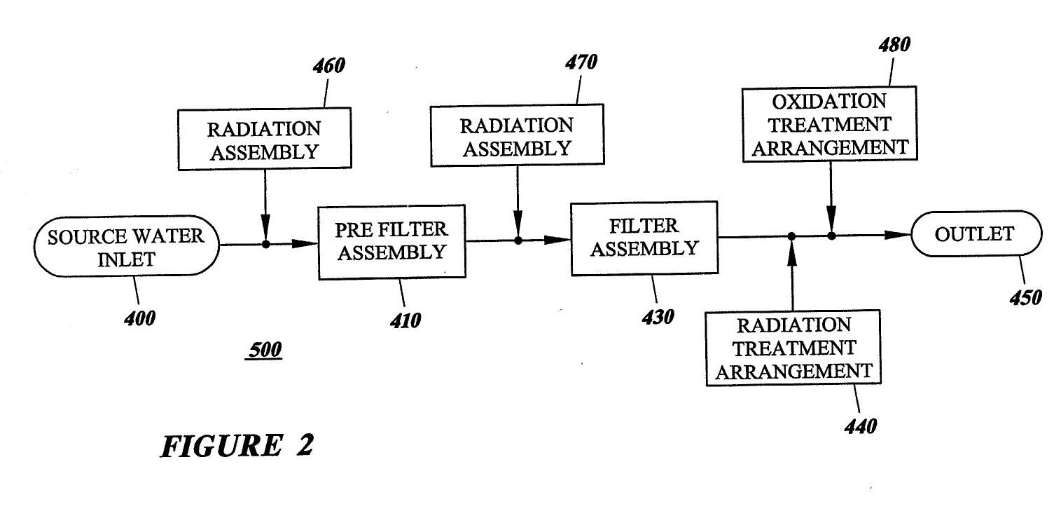

FIG. 2 illustrates one example of an embodiment of a source water treatment system 500 and method. Source water enters the source water treatment system 500 via an inlet 400 and is directed to the inlet of the prefilter assembly 410 and/or any other suitable pretreatment arrangement. The water passes through the filter medium of the prefilter assembly 410, e.g., a 400μ strainer, where larger particulates and organisms are removed, and hence to the outlet of the prefilter assembly.

Water downstream of the prefilter assembly 410 may be directed to the inlet of the filter assembly 430, e.g., a microfiltration assembly or an ultrafiltration assembly. Preferably, the filter assembly includes cleanable and/or replaceable filter cartridges or filter modules, such as those available from Pall Corporation under the trade designation Microza. Water may pass through the filter medium of the filter assembly 430, removing particulate, biological, and/or chemical contaminants and producing filtered water as a filtrate or permeate. Any retentate (not shown) may be recirculated to any of the components of the source water purification system or to the source. The filtered permeate may be directed to the outlet of the filter assembly.

Upstream of the filter medium of the filter assembly 430, a radiation assembly 470 irradiates the water. Preferably, the radiation assembly 470 is arranged to irradiate the water before the water enters the inlet of the filter assembly 430, e.g., downstream of the prefilter assembly 410 but upstream of the filter assembly 430. However, the radiation assembly may be arranged to irradiate the water within the filter assembly, e.g., upstream of the filter medium within the filter assembly 430. Preferably, the radiation assembly 470 comprises a radiation source without a photoactive unit which directly irradiates the water. For example, the radiation assembly 470 may comprise a pulsed broadband blackbody radiation source such as that available from Pulsar Remediation Technologies, Inc., as previously described. The radiation assembly destroys or alters water borne biological and/or chemical contaminants which might otherwise contact the filter medium of the filter assembly 430, thereby further purifying the water and enhancing the flux through the filter medium of the filter assembly 430.

Preferably, a radiation assembly 460 also irradiates water upstream of the filter medium of the prefilter assembly 410. The radiation assembly 460 may be arranged to irradiate water within the prefilter assembly 410 but is preferably arranged to irradiate water upstream of the inlet of the prefilter assembly 410. The radiation assembly 460 associated with the prefilter assembly 410, which may be similar or identical to the radiation assembly 470 associated with the filter assembly, serves to destroy or alter water borne biological and/or chemical contaminants in the water which might otherwise contact the filter medium of the prefilter assembly 410.

Water which passes through the filter assembly 430 is thus highly purified. Downstream of the filter assembly 430, the water may be subject to further treatment, e.g., oxidation via chlorination 480, and/or radiation 440 and is discharged via an outlet 450 of the source water purification system 500. The purified water may be used as drinking water or used for other non-drinking purposes, e.g., industrial processes.

In some embodiments of systems and methods for treating wastewater or source water, the purified water, prior to being discharged, may be subject to a last-chance or fail-safe purification assembly, including an additional filter assembly having a filter medium disposed between the inlet and the outlet and an additional radiation assembly arranged to irradiate water. The radiation assembly is preferably located upstream of the additional filter assembly.

As previously described, a last-chance purification assembly may remove little or no contamination from the water during normal operation but during abnormal conditions, e.g.,_failure of one or more components upstream of the last chance purification assembly or abnormally high concentration of contaminants, the last-chance purification assembly provides a more significant amount of purification, e.g., removing, destroying and/or altering one or more of the contaminants which reach the last-chance purification assembly. For many embodiments the filter assembly of the last chance purification assembly may comprise a pleated filter assembly available from Pall Corporation under the trade designation Septra GB and the pulsed, broadband radiation assembly may comprise the radiation assembly available from Pulsar Remediation Technologies, Inc.

The type of filter assembly utilized with the purification assembly is not particularly limited and may be similar or identical to the first filter assembly of the wastewater treatment system or the filter assembly of the_source water treatment system. For example, it may have any of the types, configurations, filter media, and/or pore sizes/structures/removal ratings described above for the first filter assembly of the wastewater treatment system or the filter assembly of the source water treatment system. Thus,_the filter assembly may be a dead-end filtration assembly or a cross-flow filtration assembly and may be configured as a plate-and-frame or stacked plate filter assembly, a dynamic filter assembly, or a granular bed filter assembly. The filter element(s) may be configured in flat sheet form, as a cylindrical element, a hollow fiber module, or a hollow pleated configuration. The flow through the filter element may be outside-in or may be inside-out. The filter media may include mono- or multi-component granular media, porous inorganic or organic media, polymeric media, or fibrous media, porous or semipermeable films, or porous hollow fibers. The filter media may alternatively or additionally include chemically, catalytically, and/or physically active media, such as various resins, various “activated” forms of carbon, sorbents, catalysts, getters and/or biocides, all as previously described.

The radiation assembly associated with the last-chance filter assembly may be similar or identical to the radiation assembly associated with the wastewater treatment system and/or source water treatment system and may have any or all of the features previously described. The radiation assembly may be arranged to irradiate the water directly and/or indirectly upstream of the filtration assembly, where “upstream of the filter medium” includes in, on, or upstream of the filter medium. Alternatively or additionally, the radiation assembly may be positioned to irradiate the water directly and/or indirectly by irradiating the upstream surface of the filter medium. In embodiments where the surfaces of the filter medium are irradiated, the filter medium is even further cleaned of any biofilm by killing organisms and oxidation of organic matter on the surfaces of the filter medium.

The characteristics of the filter assembly and the associated radiation assembly of the last-chance purification assembly, e.g., the type, configuration and/or pore rating or the wavelength and nature of the radiation may depend on many factors, including for example the various contaminants to be removed and the desired level of purity. It may be desirable to target specific contaminants to be removed during abnormal conditions, e.g., biological contaminants including organisms such as Cryptosporidium and Giardia, and select the characteristics of the filter assembly and the characteristics of the associated radiation assembly in accordance with these targets. For example, the removal rating of the fail-safe filter medium may be small enough to capture particulates and microorganisms such as bacteria and/or protozoa, e.g., Cryptosporidium and Giardia, or viruses. Alternatively, it may be desirable to target all of the potential contaminants and more generally design the characteristics of the filter assembly and the characteristics of the radiation assembly in accordance with these general targets.

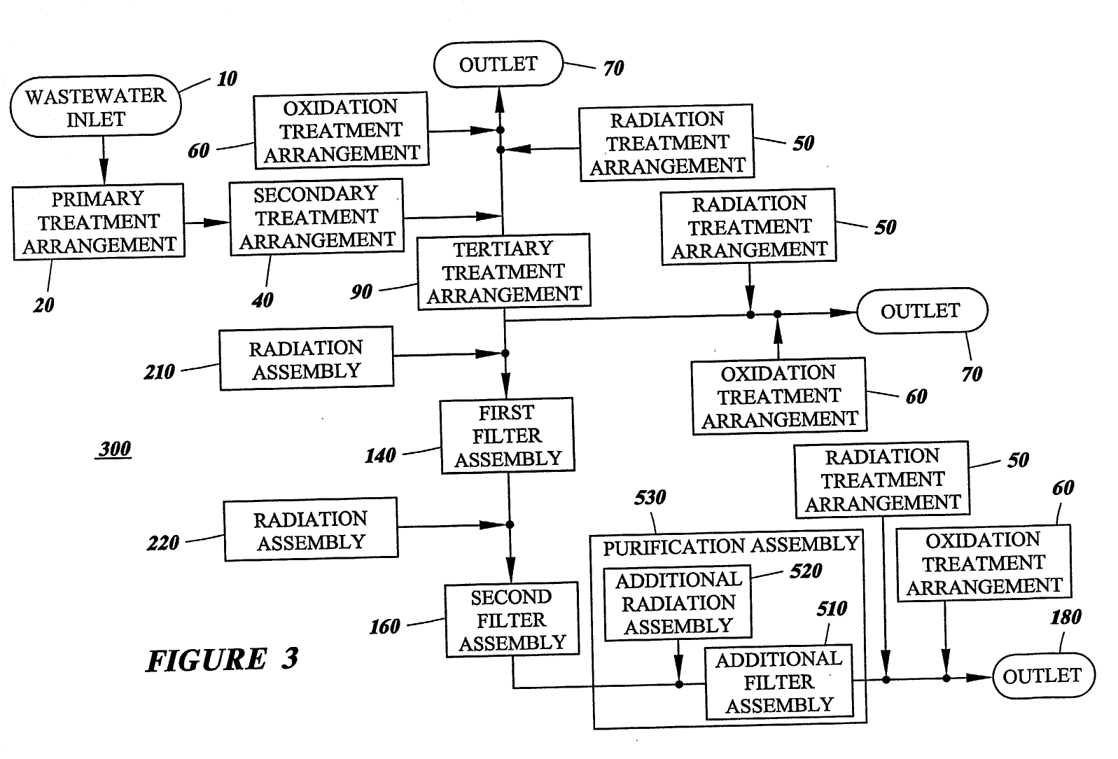

FIG. 3 illustrates one example of an embodiment of a wastewater treatment system and method including a last-chance purification assembly 530. The wastewater treatment system 300 shown in FIG. 3 is preferably similar to the wastewater treatment system shown in FIG. 1 and may include any or all of the components, features, functions, and alternatives previously described with respect to FIG. 1. Alternatively, a wastewater treatment system including a last-chance purification assembly may be different from the wastewater treatment system 300 shown in FIG. 1 and may exclude one or more of the components, features, functions and alternatives described with respect to FIG. 1 and/or may include additional components, features, functions, and alternatives over those described with respect to FIG. 1.

As shown in FIG. 3, purified water downstream of the second filter assembly 160 may be directed to the inlet of the additional filter assembly 510 of the last-chance purification assembly 530. Under normal operating conditions, the filter assembly 510 of the last-chance purification assembly 530 may filter little or no contaminants from the purified water because the components of the wastewater treatment system 300 upstream of the last-chance purification assembly 530 (i.e., the purification subsystem) provide the desired level of purification. However, during abnormal conditions, e.g., in case of an upstream filtration failure, the filter assembly 510 preferably serves as a last-chance filter assembly removing one or more of the contaminants which enters the last-chance purification assembly 530.

Upstream of the additional filter assembly 510, a radiation assembly 520 is arranged to irradiate the water preferably before the water enters the inlet of the additional filter assembly 510, e.g., downstream of the second filter assembly 160 but upstream of the additional filter assembly 510. However, the radiation assembly may be arranged to irradiate the water within the additional filter assembly, e.g., upstream of the filter medium within the filter assembly. Like the filter assembly 510, the additional radiation assembly 520 of the last-chance purification assembly 530 may, during normal operation, destroy or alter few, if any, contaminants in the water. However, during abnormal conditions, the additional radiation assembly 520 preferably serves to destroy or alter one or more of the contaminants which enter the last-chance purification assembly 530.

Downstream of the last-chance purification assembly 530, the purified water may be discharged via an outlet 180 of the wastewater purification system 300. Prior to being discharged, the water may be further treated, for example, by radiation 50 and/or oxidation 60.

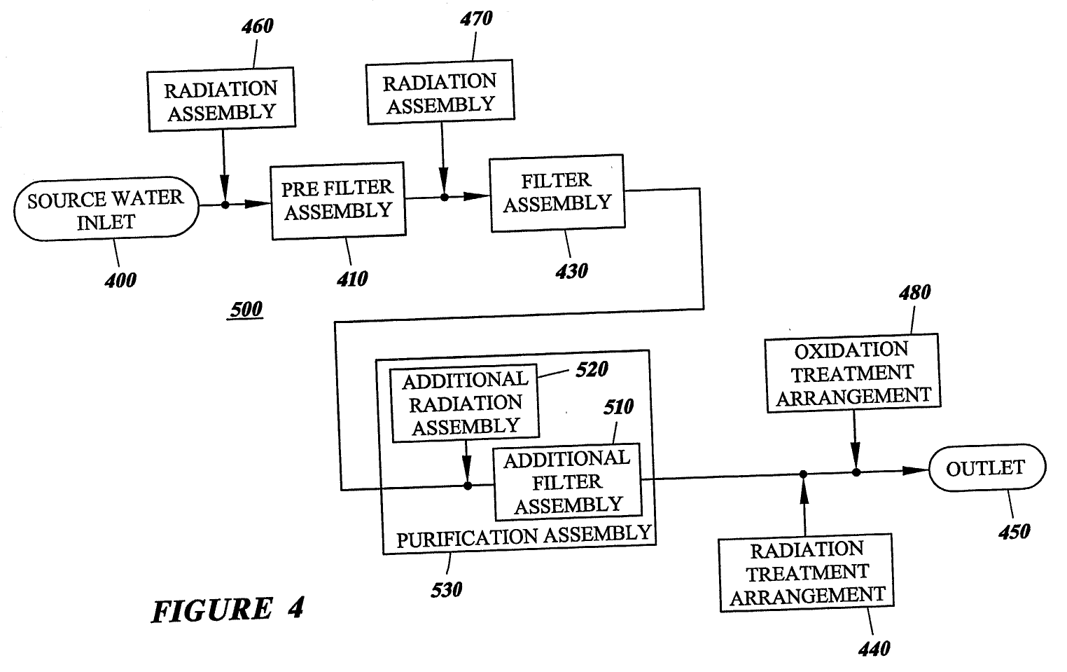

FIG. 4 illustrates one example of a source water purification system and method including a last-chance purification assembly. The source water purification system 500 may be similar to the source water purification system 500 shown in FIG. 2 and may include any or all of the components, features, functions, and alternatives previously described with respect to FIG. 2. Alternatively, a source water treatment system including a last-chance purification assembly may be different from the source water treatment system 500 shown in FIG. 2 and may exclude one or more of the components, features, functions and alternatives described with respect to FIG. 2 and/or may include additional components, features, functions, and alternatives over those described with respect to FIG. 2. For example, one or both of the radiation assemblies 460, 470 may be eliminated and/or the prefilter assembly 410 and/or the filter assembly 430 may be eliminated and replaced with any other suitable treatment arrangement.

As shown in FIG. 4, purified water downstream of the filter assembly 430 may be directed to the inlet of the filter assembly 570 of the last-chance purification assembly 530. Under normal operating conditions, the additional filter assembly 510 may filter little or no contaminants from the purified water because the components of the source water treatment system 500 upstream of the last-chance purification assembly 530 (i.e., the purification subsystem) provide the desired level of purification. However, during abnormal conditions, e.g., in case of an upstream filtration failure, the filter assembly 510 preferably serves as a last-chance filter assembly, removing one or more of the contaminants which enters the last-chance purification assembly 530.

Upstream of the filter assembly 510, a radiation assembly 520 of the last-chance purification assembly 530 may be arranged to irradiate the water before the water enters the inlet of the filter assembly 510, e.g., downstream of the filter assembly 430 but upstream of the filter assembly 510. However, the radiation assembly may be arranged to irradiate the water within the filter assembly of the last-chance purification assembly, e.g., upstream of the filter medium within the filter assembly. Downstream of the filter assembly 510, the purified water is discharged via an outlet 450 of the source water purification system 500. Prior to being discharged, the water may be further treated, for example, by radiation 440 and/or oxidation 480.

According to the various aspects of the present invention, systems and methods for treating source water, as well as systems and methods for treating wastewater, offer many advantages not found in conventional purification systems and methods. For example, by irradiating source water or wastewater upstream of a filter medium, particularly a filter medium having a removal rating of about 1 micron or less, the buildup of organic matter (e.g., total organic carbon or TOC) and biofilm on the filter media is significantly reduced or prevented, allowing greater flux of water through the filter medium, lower differential pressure or transmembrane pressure, and less frequent cessation of filtration for cleaning and/or replacing of the filter medium. Further, the irradiation of the water, especially by a pulsed, broadband, blackbody radiation source, has been found to be surprisingly efficient and effective as part of wastewater and or source water purification, especially in combination with microporous or finer filtration. The radiation kills microorganisms, such as ocysts, destroys many chemical contaminants, and oxidizes various metals to insoluble form, while the filter medium removes particulates, microorganisms, and other organic matter including larger chemical contaminants. Accordingly, the filter medium and the radiation work in tandem to purify water, such as wastewater and source water, for municipal and/or industrial use.

Although the present invention has been described in terms of exemplary embodiments, it is not limited to these embodiments. Alternative embodiments, examples, and modifications which would still be encompassed by the invention may be made by those skilled in the art, particularly in light of the foregoing teachings. Therefore, the following claims are intended to cover any alternative embodiments, examples, modifications, or equivalents which may be included within the spirit and scope of the invention as defined by the claims.

What is claimed is:

1. A method for treating wastewater comprising:
directing water through at least one of a primary, secondary and tertiary water treatment arrangement;
directing water through a first filter assembly having a filter medium; and
irradiating the water.

2. The method of claim 1 wherein directing water through at least one of a primary, secondary and tertiary water treatment arrangement comprises removing contaminants and directing water through the first filter assembly comprises filtering little or no contaminants during normal operating conditions, whereby the first filter assembly serves as a last-chance filter.

3. The method of claim 1 further comprising directing water through a purification assembly including directing water through an additional filter assembly and irradiating the water, wherein directing water through a first filter assembly comprises removing contaminants and directing water through the additional filter assembly comprises filtering little or no contaminants during normal operating conditions, whereby the purification assembly serves as a last-chance purifier.

4. The method of claim 1 further comprising directing water through a second filter assembly having a porous medium and being disposed downstream of the first filter assembly.

5. The method of claim 4 wherein directing water through a second filter assembly comprises directing water through a reverse osmosis assembly.

6. A system for treating wastewater comprising:
an inlet for receiving wastewater;
an outlet for discharging treated water;
at least one of a primary, secondary, and tertiary water treatment arrangement disposed between the inlet and the outlet;
a first filter assembly having a filter medium disposed between the inlet and the outlet; and
a radiation assembly arranged to irradiate water between the inlet and the outlet.

7. The system of claim 6 further comprising a purification assembly comprising an additional filter assembly and an additional radiation assembly, the purification assembly being disposed downstream of the first filter assembly and the additional filter assembly filtering little or no contaminants during normal operating conditions, whereby the purification assembly serves as a last-chance purifier.

8. The system of claim 6 further comprising a second filter assembly having a porous medium and being disposed downstream of the first filter assembly, the porous medium of the second filter assembly being finer than the filter medium of the first filter assembly.

9. The system of claim 8 wherein the second filter assembly comprises a reverse osmosis assembly.

10. A method for treating source water comprising:
directing water through a filter assembly having a filter medium and
irradiating the water.

11. The method of claim 10 further comprising directing water through a purification assembly including directing water through an additional filter assembly and irradiating the water, wherein directing water through the filter assembly comprises removing contaminants and directing water through the additional filter assembly comprises filtering little of no contaminants, whereby the purification assembly serves as a last-chance purifier.

12. The method of claim 10 wherein directing water through a pretreatment arrangement includes directing water through a prefilter assembly having a filter medium.

13. A system for treating source water comprising:
an inlet for receiving source water;
an outlet for discharging water;
a filter assembly having a filter medium disposed between the inlet and the outlet; and
a radiation assembly arranged to irradiate the water between the inlet and the outlet.

14. The system of claim 13 further comprising a purification assembly comprising an additional filter assembly and an additional radiation assembly, the purification assembly being disposed downstream of the filter assembly and the additional filter assembly filtering little or no_contaminants under normal operating conditions, whereby the purification assembly serves as a last-chance purifier.

15. The system of claim 13 further comprising a pretreatment arrangement disposed upstream of the filter assembly.

16. The system of claim 13 wherein the pretreatment arrangement comprises a prefilter assembly having a filter medium.

17. A method for treating water comprising:
directing the water through a purification subsystem including removing contaminants to a desired level of purification during normal operating conditions; and
then directing the water through a last-chance purification assembly which includes a filter assembly and a radiation assembly, including removing little or no contaminants during normal operating conditions and removing contaminants during abnormal conditions.

18. The method of claim 17 wherein the water comprises wastewater.

19. The method of claim 17 wherein the water comprises source water.

20. A system for treating water comprising:
a purification subsystem which removes contaminants to a desired level of purification during normal operating conditions; and
a last-chance purification assembly including a filter assembly and a radiation assembly, the last-chance purification assembly being located downstream of the purification subsystem and being arranged to remove little or no contaminants during normal operating conditions and to remove contaminants during abnormal conditions.
